(19) United States
(12) Patent Application Publication
(10) Pub. No.: US 2017/0005361 A1
(43) Pub. Date: Jan. 5, 2017

(54) NONAQUEOUS ELECTROLYTE SECONDARY BATTERY

(71) Applicants: Hisamitsu KAMEZAKI, Kanagawa (JP); Nobuaki ONAGI, Kanagawa (JP); Masaki YOSHIO, Saga (JP)

(72) Inventors: Hisamitsu KAMEZAKI, Kanagawa (JP); Nobuaki ONAGI, Kanagawa (JP); Masaki YOSHIO, Saga (JP)

(73) Assignee: Ricoh Company, Ltd., Tokyo (JP)

(21) Appl. No.: 15/038,938

(22) PCT Filed: Dec. 5, 2014
(86) PCT No.: PCT/JP2014/082905

§ 371 Date: May 24, 2016

(30) Foreign Application Priority Data
Dec. 5, 2013 (JP) 2013-251896
Sep. 22, 2014 (JP) 2014-192458

(51) Int. Cl. H01M 10/0525; H01M 10/0569; H01M 4/485; H01M 4/587; H01M 4/36

(52) U.S. Cl. CPC H01M 10/0525; H01M 4/587; H01M 4/366; H01M 4/485; H01M 10/0569; H01M 2300/0037

(57) ABSTRACT

A nonaqueous electrolyte secondary battery, which contains: an anode capable of accumulating or releasing metal lithium, or a lithium ion, or both; a cathode relative to the anode; and a nonaqueous electrolyte, in which a lithium salt is dissolved in a nonaqueous solvent, wherein, after repeating charge of the nonaqueous electrolyte secondary battery to an overcharge region and discharge for the charge 20 times, a charge capacity of the nonaqueous electrolyte secondary battery for 21st charge is a capacity equal to or greater than 100% SOC (State of Charge), where 100% SOC is an arbitrary capacity indicating that electric potential of the anode is reduced by 5% or greater based on a relative value, compared to electric potential thereof when SOC is 0%.

### TECHNICAL FIELD

The present invention relates to a nonaqueous electrolyte secondary battery.

### BACKGROUND ART

As electric appliances of recent years have reduced their weight and size, developments of a nonaqueous electrolyte secondary battery having a high energy density have been conducted. Moreover, there are needs for improvement in battery properties of a nonaqueous electrolyte secondary battery, as fields of application thereof have been expanded.

A nonaqueous electrolyte secondary battery is composed of at least a cathode, an anode, and a nonaqueous electrolyte, in which a lithium salt is dissolved in a nonaqueous solvent. As for the anode, metal capable of accumulating and releasing metal lithium or a lithium ion, a metal compound (including oxide, and an alloy with lithium) or a carbonaceous material is used. As for the carbonaceous material, for example, proposed are coke, artificial graphite, and natural graphite. In this type of the nonaqueous electrolyte secondary battery, formation of dendrite is suppressed, as lithium is not present in a metal state. Therefore, a service life and safety of the nonaqueous electrolyte secondary battery can be improved. Especially, a nonaqueous electrolyte secondary battery using a graphite-based carbonaceous material, such as artificial graphite, and natural graphite, has been attracting attentions as a battery that meets the demand for high capacity batteries.

Meanwhile, two materials have been known as a cathode active material of a nonaqueous electrolyte secondary battery depending on an embodiment of a reaction during charging and discharging.

The first type of the materials carries out charge and discharge by releasing and inserting lithium ions between crystal layers thereof. Examples thereof include oxide of transition metal (e.g., Fe, Co, Ni, Mn, V, and Ti), and an inorganic compound, such as complex oxide of any of these transition metals and lithium, and sulfide thereof.

Specific examples thereof include: transition metal oxide (e.g., MnO, V₂O₅, V₆O₁₃, and TiO₂); a complex oxide of lithium and a transition metal, such as lithium-nickel complex oxide whose basic composition is LiNiO2, lithium-cobalt complex oxide (LiCoO₂), and lithium-manganese complex oxide (LiMnO₂ or LiMnO₄); and transition metal sulfide, such as TiS₂, and FeS. Among them, a complex oxide of lithium and a transition metal, such as lithium-nickel complex oxide, lithium-cobalt complex oxide, and lithium-manganese oxide, is preferably used, as it can achieve both high capacity and desirable cycle properties.

The second type of the materials is a material, which inserts and releases mainly anions in a cathode, such as a conductive polymer, and a carbonaceous material. Examples thereof include polyaniline, polypyrrole, polyparaphenylene, and graphite.

The battery using the second type of the cathode active material carries out charge, as anions, such as PF₆⁻, are inserted into the cathode from the electrolyte, and Li⁺ is inserted into the anode from the electrolyte. The battery carries out discharge by releasing PF₆⁻ from the cathode, and Li⁺ from the anode.

As for an example of such a battery, known is a dual carbon cell, where graphite is used as a cathode, pitch coke is used as an anode, and a solution, in which lithium perchlororate is dissolved in a mixed solvent of propylene carbonate and ethylmethyl carbonate, is used as an electrolyte.

As a solvent of a nonaqueous electrolyte of a nonaqueous electrolyte secondary battery, moreover, an aprotic solvent, which has high decomposition voltage, having high dielectric constant is used. Examples thereof include a mixed solvent of propylene carbonate, and ethylmethyl carbonate.

In such the nonaqueous electrolyte secondary battery, however, a solvent used in a nonaqueous electrolyte typically starts decomposing, as voltage, as a voltage of a cathode in the case where lithium is used as a reference electrode in a conventional art, is increased to 5 V or greater. Therefore, it is difficult to perform charge to a cathode, and there is a problem that a capacity thereof is low as a secondary battery.

As a conventionally known example where a cathode is charged to high voltage and discharge can be performed therefore, NPL 1 discloses an example where charge can be performed to 5.2 V, when graphite is used as a cathode, an electrolyte, in which LiBF₄ is dissolved in sulfolane, is used, and lithium is used as a reference electrode. It is however a common knowledge that charge is not performed to the electric potential equal to or higher than that.

Meanwhile, an electric double-layer capacitor using graphite as a cathode material and a carbonaceous material as an anode material has excellent electric capacity and voltage resistance compared to a conventional electric condenser using activated carbon as an electrode (see PTL 1). Moreover, an example where high capacity of a battery is achieved by using titanium oxide as an anode material is disclosed in PTL 2, and an example where a copolymer material is added to a cathode of a battery is disclosed in PTL 3.

Considering the aforementioned technical background, a study for using graphite as a cathode and lithium titanate as an anode has been actively conducted (see PTL 4 to PTL 10). However, these studies have not taught an experimental result where a coating weight of an anode is varied, and an effect thereof.

### CITATION LIST

### Patent Literature

PTL 1: Japanese Patent Application Laid-Open (JP-A) No. 2005-294780
PTL 2: JP-A No. 2008-124012
PTL 3: Japanese Patent (JP-B) No. 3539448
PTL 4: JP-B No. 3920310
PTL 5: JP-B No. 4081125
PTL 6: JP-B No. 4194052
PTL 7: JP-A No. 2006-332627
PTL 8: JP-A No. 2006-332626
PTL 9: JP-A No. 2006-332625
PTL 10: JP-A No. 2008-042182

### Non-Patent Literature

NPL 1: J. Electrochem. Soc., 118,461

### SUMMARY OF INVENTION

### Technical Problem

When a nonaqueous electrolyte secondary battery is overcharged, the battery is typically protected by circuits thereof. In the case where an unexpected phenomenon occurs, or circuits are broken down, the battery is overcharged, and the battery may cause ignition.

Accordingly, the present invention aims to provide a safe nonaqueous electrolyte secondary battery securing an overcharge region, which has not yet been realized in the conventional art.

### Solution to Problem

The nonaqueous electrolyte secondary battery of the present invention, as the means for solving the aforementioned problems, contains:

an anode capable of accumulating or releasing metal lithium, or a lithium ion, or both;

a cathode relative to the anode; and

a nonaqueous electrolyte, in which a lithium salt is dissolved in a nonaqueous solvent, wherein, after repeating charge of the nonaqueous electrolyte secondary battery to an overcharge region and discharge for the charge 20 times, a charge capacity of the nonaqueous electrolyte secondary battery for 21st charge is a capacity equal to or greater than 100% SOC (State of Charge), where 100% SOC is an arbitrary capacity indicating that electric potential of the anode is reduced by 5% or greater based on a relative value, compared to electric potential thereof when SOC is 0%.

### Advantageous Effects of Invention

The present invention can provide a safe nonaqueous electrolyte secondary battery securing an overcharge region, which has not yet been realized in the conventional art.

### BRIEF DESCRIPTION OF DRAWINGS

FIG. 1 is a diagram illustrating a relationship between a weight ratio (anode/cathode) of a cathode and anode of the secondary battery of Example 1, and a charge capacity of the first charge.

FIG. 2 is a diagram illustrating the results of repeating a charge-discharge cycle achieving 100% SOC (SOC=100%) or greater performed on the secondary battery (weight ratio: 2.0 to 0.4) of Example 1 and the secondary battery of Example 2.

FIG. 3 is a diagram illustrating one example of a charge-discharge curve of the secondary battery (weight ratio: 2.0) of Example 1.

FIG. 4 is a diagram illustrating one example of a charge-discharge curve of the secondary battery of Example 2.

### DESCRIPTION OF EMBODIMENTS

The nonaqueous electrolyte secondary battery of the present invention contains at least an anode, a cathode, and a nonaqueous electrolyte, preferably further contains a separator, and may further contain other members according to the necessity.

The nonaqueous electrolyte secondary battery is characterized by that the nonaqueous electrolyte secondary battery can be charged with conditions that the charge capacity thereof for the 21^{st} charge is 100% SOC (state of charge) or greater after repeating charge beyond a overcharge region and discharge relative to the charge 20 times.

Note that, 100% SOC (SOC=100%) is determined as an arbitrary capacity indicating that electric potential of the anode is reduced by 5% or greater based on a relative value, compared to electric potential thereof when SOC is 0%.

A weight ratio (the active material of the anode/the active material of the cathode) of the active material of the anode to the active material of the cathode is preferably 0.4 or greater.

A charge capacity of the cathode is preferably 24 mAh/g or greater, more preferably 58 mAh/g or greater, even more preferably 120 mAh/g or greater, and particularly preferably 180 mAh/g or greater.

Moreover, the nonaqueous electrolyte secondary battery is characterized in that the cathode contains graphite-carbon composite particles each containing a graphite particle, and a carbon layer covering the graphite particle, the anode contains lithium titanate represented by the general formula: LixTiyO₄ (0.8≦x≦1.4, 1.6≦y≦2.2), a weight ratio of an active material of the anode to an active material of the cathode, which is represented by (the active material of the anode/the active material of the cathode), is 0.4 or greater, and after repeating charge of the nonaqueous electrolyte secondary battery to 100% SOC or greater and discharge of the nonaqueous electrolyte secondary battery for the charge twice, a charge capacity of the nonaqueous electrolyte secondary battery for third charge is a capacity equal to or greater than 100% SOC, where 100% SOC is an arbitrary capacity indicating that electric potential of the anode is reduced by 5% or greater based on a relative value, compared to electric potential thereof when SOC is 0%.

A charge capacity of the cathode is preferably 24 mAh/g or greater.

### <Cathode>

The cathode is appropriately selected depending on the intended purpose without any limitation, provided that the cathode contains a cathode active material. Examples of the cathode include a cathode equipped with a cathode material containing cathode active material, which is provided on a cathode collector.

A shape of the cathode is appropriately selected depending on the intended purpose without any limitation, and examples thereof include a plate shape.

### <<Cathode Material>>

The cathode material for use in the present invention is appropriately selected depending on the intended purpose without any limitation. For example, the cathode material contains at least a cathode active material, and may further contain a binder, a thickening agent, and a conducting agent, according to the necessity.

### —Cathode Active Material—

The cathode active material is appropriately selected depending on the intended purpose without any limitation, provided that the cathode active material is a material capable of accumulating and releasing anions. Examples thereof include a carbonaceous material, and a conductive polymer. Among them, a carbonaceous material is preferable in view of its high energy density.

Examples of the conductive polymer include polyaniline, polypyrrole, and polyparaphenylene.

Examples of the carbonaceous material include: black-lead (graphite), such as coke, artificial graphite, and natural graphite; and a thermal decomposition product of an organic material under various thermal decomposition conditions. Among them, artificial graphite, and natural graphite are particularly preferable. Moreover, the carbonaceous material is preferably a carbonaceous material having high crystallinity. The crystallinity can be evaluated by X-ray diffraction, or Raman analysis. For example, in a powder X-ray diffraction pattern thereof using CuKα rays, the intensity ratio I_{2θ=22.3°}/I_{2θ=26.4°} of the diffraction peak intensity I_{2θ=22.3°} at 2θ=22.3° to the diffraction peak intensity I_{2θ=26.4°} at 2θ=26.4° is preferably 0.4 or less.

Note that, I_{2θ=22.3} is a diffraction peak intensity at 2θ=22.3°, and I_{2θ=26.4} is a diffraction peak intensity at 2θ=26.4°.

A BET specific surface area of the carbonaceous material as measured by nitrogen adsorption is preferably 1 m²/g to 100 m²/g. The average particle diameter (median diameter) of the carbonaceous material as measured by a laser diffraction-scattering method is preferably 0.1 μm to 100 μm.

As for the carbonaceous material of the cathode, graphite-carbon composite particles are preferable. The graphite-carbon composite particles means composite particles in which a coating layer of carbon is formed on surfaces of graphite particle. Use of the graphite-carbon composite particles in the cathode can significantly improve charge-discharge speed.

In a polarizable electrode, an electrolyte is adsorbed on a surface of the carbonaceous material to express an electrostatic capacity. Therefore, it has been considered effective to increase a surface area of the carbonaceous material in order to improve the electrostatic capacity. This idea is applied not only to activated carbon, which is originally porous, but also to nonporous carbon having microcrystal carbon, similar to graphite. The non-porous carbon exhibits electrostatic capacity after irreversibly swollen by first charge (electric field activation). This is because the non-porous carbon is also theoretically porous, as a result that spaces between layers are opened up with electrolyte ions or a solvent by the first charge.

On the other hand, graphite has an extremely small specific surface area compared to activated carbon or non-porous carbon, and has high crystalline. Moreover, the graphite exhibits electrostatic capacity at first charge, and swollenness caused during charge is reversible and therefore the graphite has a low expansion coefficient. Accordingly, the graphite has exhibits behavior that it is not made porous by electric field activation. Specifically, the graphite is an extremely disadvantageous material for exhibiting electrostatic capacity.

A carbon covering each surface of the graphite particles may be amorphous carbon, low crystalline carbon, or crystalline carbon. It is particularly preferred that the carbon covering each surface of the graphite particles be crystalline carbon, as a speed for absorbing and releasing ions is improved.

A material, in which surfaces of graphite particles are covered with amorphous carbon or low crystalline carbon, is known in the art, and examples thereof include a composite material where graphite is covered with low crystalline carbon by chemical vapor deposition, a composite material where graphite is covered with carbon having the average interlayer distance d002 of 0.337 nm or greater, and a composite material where graphite is covered with amorphous carbon.

As for a method for coating surfaces of graphite particles with crystalline carbon, chemical vapor deposition using a fluidized-bed reacting furnace is excellent. Examples of organic matter used as a carbon source of chemical vapor deposition include: aromatic hydrocarbon, such as benzene, toluene, xylene, and styrene; and aliphatic hydrocarbon, such as methane, ethane, and propane.

To the fluidized-bed reacting furnace, the aforementioned organic matter is introduced with blending with inert gas, such as nitrogen. A concentration of the organic matter in the mixed gas is preferably 2 mol % to 50 mol %, more preferably 5 mol % to 33 mol %. The temperature for chemical vapor deposition is preferably 850° C. to 1,200° C., more preferably 950° C. to 1,150° C. By performing chemical vapor deposition under the aforementioned conditions, surfaces of the graphite particles can be uniformly and completely covered with AB planes (i.e., basal surfaces) of crystalline carbon.

An amount of the carbon required for forming a coating layer varies depending on particle diameters or shapes of the graphite particles, but the amount thereof is preferably 0.1% by mass to 24% by mass, more preferably 0.5% by mass to 7% by mass, and even more preferably 0.8% by mass to 5% by mass, relative to a total amount of the composite material. When the amount of the carbon is less than 0.1% by mass, an effect obtainable by coating cannot be exhibited. When the amount thereof is greater than 24% by mass, on the other hand, a problem, such as reduction in a charge-discharge capacity, may occur because a ratio of the graphite is reduced.

A raw material used for the graphite particle may be natural graphite or artificial graphite, but specific surface area thereof is preferably 10 m²/g or less, more preferably 7 m²/g or less, and even more preferably 5 m²/g or less. The specific surface area can be determined by a BET method using N₂ or CO₂ as an adsorbing agent.

Moreover, the graphite preferably has high crystallinity. For example, the crystal lattice constant CO of the 002 plane thereof is preferably 0.67 nm to 0.68 nm, more preferably 0.671 nm to 0.674 nm.

Moreover, a half value width of the 002 peak in an A-ray crystal diffraction spectrum thereof using CuKα rays is preferably less than 0.5, more preferably 0.1 to 0.4, and even more preferably 0.2 to 0.3.

When the crystallinity of the graphite is low, the capacity of the electric double-layer capacitor increases irreversibly.

The graphite preferably has appropriate disturbance with graphite layers, and a ratio of the basal plane and the edge plane within a constant range. The disturbance of the graphite layers are, for example, appeared in the analysis result of Raman spectroscopy. As for the preferably graphite, the peak intensity ratio [I(1360)/I(1580)] of the peak intensity at 1,360 cm⁻¹ in the Raman spectrum thereof to the peak intensity at 1,580 cm⁻¹ in the Raman spectrum thereof is preferably 0.02 to 0.5, more preferably 0.05 to 0.25, even more preferably 0.1 to 0.2, and particularly preferably about 0.16 (e.g., 0.13 to 0.17).

Note that, the aforementioned intensity ratio cannot be achieved when CVD is performed, and the intensity ratio becomes 2.5 or greater. This is probably because the coating carbon has low crystallinity than the crystallinity of the base material.

Moreover, the preferably graphite can be determined with the result of X-ray diffraction spectroscopy. Specifically, a ratio (Ib/Ia) of a peak intensity (Ib) of a rhombohedron in the X-ray crystal diffraction spectrum of the preferably graphite to a peak intensity (Ia) of a hexagonal crystal in the spectrum thereof is preferably 0.3 or greater, more preferably 0.35 to 1.3.

Shapes or sizes of the graphite particles are not particularly limited, as long as resulting graphite-carbon composite particles can form a polarizable electrode. For example, flaky graphite particles, compacted graphite particles, or spherical graphite particles can be used. Characteristics and production methods of these graphite particles are known in the art.

A thickness of each flaky graphite particle is typically 1 μm or less, preferably 0.1 μm or less, and the maximum particle length thereof is 100 μm or less, preferably 50 μm or less.

The flaky graphite particles can be obtained by chemically or mechanically pulverizing natural graphite or artificial graphite.

For example, the flaky graphite particles can be produced by a conventional method, such as a method where natural graphite, or an artificial graphite material (e.g., kish graphite, and highly crystalline thermally-decomposed graphite) is treated with mixed acid of sulfuric acid and nitric acid, followed by heating to obtain swollen graphite, and then the graphite is pulverized with ultrasonic waves, and a method where an intercalational compound of graphite-sulfuric acid obtained by electrochemically oxidizing graphite in sulfuric acid, or an intercalational compound of graphite-organic matter is rapidly heated by an externally heated furnace, an internally heated furnace, or a laser to swollen the graphite, followed by pulverizing the graphite.

Moreover, the flaky graphite can be obtained by mechanically pulverizing natural graphite or artificial graphite, for example, by means of a jet mill.

The flaky graphite particles are obtained, for example, by forming natural graphite or artificial graphite into flakes or particles. Examples of a method for forming flakes or particles from the graphite include a method where natural graphite or artificial graphite is mechanically or physically pulverized with ultrasonic waves, or by any of various pulverizers.

In the present specification, the graphite particles, which is obtained by pulverizing natural graphite or artificial graphite to turn into flakes by means of a pulverizer that does not apply shear, such as a jet mill, are called flake graphite particles. Meanwhile, the graphite particles, which are obtained by pulverizing swollen graphite with ultrasonic waves to turn into flakes, are called foliated graphite.

The flaky graphite particles may be subjected to annealing in an inert atmosphere at 2,000° C. to 2,800° C. for about 0.1 hours to about 10 hours, to further enhance crystallinity thereof.

The compacted graphite particles are graphite particles having high bulk density, and the tap density thereof is typically 0.7 g/cm³ to 1.3 g/cm³. In the present specification, the compacted graphite particles means graphite particles containing spindle-shaped graphite particles having an aspect ratio of 1 to 5, in an amount of 10% by volume or greater, or graphite particles containing disc-shaped graphite particles having an aspect ratio of 1 to 10 in an amount of 50% by volume or greater.

The compacted graphite particles can be produced by forming raw material graphite particles into compacts.

As for the raw material graphite particles, natural graphite or artificial graphite may be used. Use of natural graphite is however preferable because of high crystallinity thereof and readily availability. The graphite can be pulverized as it is to provide raw material graphite particles. However, the aforementioned flaky graphite particles may be used as the raw material graphite particles.

The compact treatment is carried out by applying impulse to the raw material graphite particles. The compact treatment using a vibration mill is more preferable, as the density of the compacted graphite particles can be increased. Examples of the vibration mill include a vibration ball mill, a vibration disk mill, and a vibration rod mill.

When the flaky raw material graphite particles having a large aspect ratio is subjected to a compact treatment, the raw material graphite particles are mainly two-dimensionally formed into particles with laminating at basal planes of the graphite. At the same time, edges of the laminated two-dimensional particles are rounded to turn particles into disc-shaped thick particles having an aspect ratio of 1 to 10, spindle-shaped particles having an aspect ratio of 1 to 5. In this manner, the graphite particles are turned into graphite particles having a small aspect ratio.

By turning the graphite particles into graphite particles having a small aspect ratio in the aforementioned manner, graphite particles having excellent isotropy, and high tap density can be attained with high crystallinity.

In the case where the obtained graphite-carbon composite particles are formed into a polarizable electrode, therefore, a graphite concentration in graphite slurry can be made high, and a resulting electrode has a high graphite concentration.

The spherical graphite particles can be obtained by collecting flakes while pulverizing highly crystalline graphite by means of an impulsive pulverizer giving relatively small pulverization force, to form into spherical compacts. As for the impulsive pulverizer, for example, a hummer mill, or a pin mill can be used. The outer peripheral linear velocity of the rotating hummer or pin is preferably about 50 m/sec to about 200 m/sec. Moreover, the graphite can be supplied to or discharged from the pulverizer with a flow of gas, such as air.

A degree of sphericity of the graphite particles can be represented by a ratio (major axis/minor axis) of a major axis of the particle to a minor axis of the particle. Specifically, when the graphite particle having the maximum value of (major axis/minor axis) among axis crossed at a center on an arbitral cross-section thereof is selected, the particle is close to sphere, as the value of the ratio is closer to 1.

The ratio (major axis/minor axis) can be easily made 4 or less (preferably 1 to 4) by the spheroidizing. Moreover, the ratio (major axis/minor axis) can be made 2 or less (preferably 1 to 2) by sufficiently performing the spheroidizing.

The highly crystalline graphite is graphite obtained by laminating large number of AB planes horizontally spreading with forming a network structure with carbon particles to increase a thickness, and growing in form of a bulk. The bonding force between the laminated AB planes (binding force in a C-axis direction) is slightly smaller than the binding force within the AB plane. As the graphite is pulverized, therefore, flaking of the AB plane having a weak bonding force is carried out preferentially, and therefore obtained particles tend to be in the form of flakes. The stripe shape lines indicating the laminate structure can be observed when a cross-section perpendicular to the AB planes of the graphite crystals is observed under an electron microscope.

The internal structure of the flake graphite is simple. As a cross-section thereof perpendicular to the AB plane is observed, the stripe-shaped lines indicating the laminate structure is always straight lines, and the structure thereof is a plate-shaped laminate structure.

On the other hand, the internal structure of the spherical graphite particle is significantly complex. The stripe-shaped lines indicating the laminate structure are often curves, and voids are often observed. Specifically, a spherical shape is formed, as of flake (plate-shaped) particle is folded, or rounded.

In this manner, a change where an originally linear laminate structure is changed to a curved structure by compression or the like is called “folding.”

Another characteristic of the spherical graphite particles is that a surface area of the particle has a curved laminate structure corresponding to a roundness of the surface even on a randomly selected cross-section thereof. Specifically, a surface of the spherical graphite particle is covered with the substantially folded laminate structure, and the outer surface is composed of the AB planes (i.e., basal planes) of the graphite crystals.

The cathode containing the graphite-carbon composite particles can be prepared using the graphite-carbon composite particles as the carbonaceous material, in the same manner as a conventional method.

In order to produce a sheet-shaped polarizable electrode, for example, after adjusting a particle size of the aforementioned graphite-carbon composite particles, conductivity adjuvant for giving electroconductivity to the graphite-carbon composite particles, and a binder are added as necessary, and a resulting mixture is kneaded, and is then shaped into a sheet by rolling.

As for the conductivity adjuvant, for example, carbon black, or acetylene black can be used. As for the binder, for example, polyvinylidene fluoride (PVDF), polytetrafluoroethylene (PTFE), polyethylene (PE), or polypropylene (PP) can be used.

Here, a blending ratio of the non-porous carbon, the conductivity adjuvant, and the binder is typically in the approximate range of 10 to 1:0.5 to 10:0.5 to 0.25.

### —Binder—

The binder resin is appropriately selected depending on the intended purpose without any limitation, provided that it is a material stable to a solvent or electrolyte used during production of an electrode. Examples of the binder include: a fluorine-based binder, such as polyvinylidene fluoride (PVDF), and polytetrafluoroethylene (PTFE); styrene-butadiene rubber (SBR); and isoprene rubber.

In the case where water or an alcohol-based solvent is used, moreover, a copolymer composed of 50 mol % to 95 mol % of acrylic acid ester or methacrylic acid ester, 3 mol % to 40 mol % of acrylnitrile, and 1 mol % to 25 mol % of a vinyl monomer containing an acid component may be contained. Examples of the acrylic acid ester or methacrylic acid ester include a compound represented by the following general formula (1). Examples of the vinyl monomer containing an acid component include acrylic acid, methacrylic acid, and maleic acid. These may be used alone, or in combination.

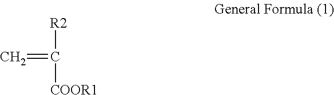

In the general formula (1), R1 is a C3-C16 alkyl group, and R2 is a hydrogen atom, or a methyl group.

### —Thickening Agent—

Examples of the thickening agent include carboxymethyl cellulose, methyl cellulose, hydroxymethyl cellulose, ethyl cellulose, polyvinyl alcohol, oxidized starch, phosphoric acid starch, and casein. These may be used alone, or in combination.

### —Conducting Agent—

Examples of the conducting agent include: a metal material, such as copper, and aluminum; and a carbonaceous material, such as carbon black, and acetylene black. These may be used alone, or in combination.

### <<Cathode Collector>>

A material, shape, size, and structure of the cathode collector are appropriately selected depending on the intended purpose without any limitation.

The material thereof is not particularly limited, as long as it is a conductive material. Examples thereof include stainless steel, nickel, aluminum, copper, titanium, and tantalum. Among them, stainless steel, and aluminum are particularly preferable. Examples of the shape thereof include a sheet shape, and a mesh shape. The size thereof is not particularly limited, as long as it can be usable in the nonaqueous electrolyte secondary battery.

### —Production Method of Cathode—

The cathode can be produced by applying a cathode material, which is prepared by optionally adding a binder, a thickening agent, a conducting agent, and solvent to the cathode active material and forming into a slurry, onto a cathode collector, and drying the applied slurry.

The solvent is appropriately selected depending on the intended purpose without any limitation, and the solvent may be an aqueous solvent, or an organic solvent. Examples of the aqueous solvent include water, and alcohol. Examples of the organic solvent include N-methylpyrrolidone (NMP), and toluene.

Note that, the cathode active material may be subjected to roll molding as it is to form a sheet electrode, or to compression molding to form a pellet electrode.

### <Anode>

The anode is appropriately selected depending on the intended purpose without any limitation, provided that the anode contains an anode active material. Examples thereof include an anode, which contains an anode material containing an anode active material, provided on an anode collector.

A shape of the anode is appropriately selected depending on the intended purpose without any limitation, and examples thereof include a plate shape.

### <<Anode Material>>

The anode material may contain, in addition to the anode active material, a binder, and a conducting agent according to the necessity.

### —Anode Active Material—

The anode active material is appropriately selected depending on the intended purpose without any limitation, provided that the anode active material is a material capable of accumulating and releasing metal lithium and/or a lithium ion. Examples thereof include: a carbonaceous material; a metal oxide capable of accumulating and releasing lithium, such as tin oxide, antimony-doped tin oxide, silicon monoxide, and vanadium oxide; a metal that can form an alloy with lithium, such as aluminum, tin, silicon, antimony, lead, arsenic, zinc, bismuth, copper, nickel, cadmium, silver, gold, platinum, palladium, magnesium, sodium, potassium, and stainless steel; an alloy containing the metal (including an intermetallic compound); a complex alloy compound of a metal capable of forming an alloy with lithium, an alloy containing the metal, and lithium; and lithium metal nitride, such as lithium cobalt nitride. These may be used alone, or in combination. Among them, a carbonaceous material is particularly preferable in view of safety and cost.

Examples of the carbonaceous material include: black-lead (graphite), such as coke, artificial graphite, and natural graphite; and a thermal decomposition product of an organic material under various thermal decomposition conditions. Among them, artificial graphite, and natural graphite are particularly preferable. The BET specific surface area of the carbonaceous material used as the anode material, such as graphite, is typically preferably 0.5 m²/g to 25.0 m²/g, and the median diameter of the carbonaceous material as measured by a laser diffraction-scattering method is typically preferably 1 μm to 100 μm.

### —Binder—

The binder is appropriately selected depending on the intended purpose without any limitation, and examples thereof include: a fluorine-based binder, such as polyvinylidene fluoride (PVDF), and polytetrafluoroethylene (PTFE); ethylene-propylene-butadiene rubber (EPBR); styrene-butadiene rubber (SBR); isoprene rubber; and carboxymethyl cellulose (CMC). These may be used alone, or in combination. Among them, a fluorine-based binder, such as polyvinylidene fluoride (PVDF), and polytetrafluoroethylene (PTFE), is particularly preferable.

### —Conducting Agent—

Examples of the conducting agent include: a metal material, such as copper, and aluminum; and a carbonaceous material, such as carbon black, and acetylene black. These may be used alone, or in combination.

### <<Anode Collector>>

A material, shape, size, and structure of the anode collector are appropriately selected depending on the intended purpose without any limitation.

A material of the anode collector is not particularly limited as long as the anode collector is formed of a conductive material. Examples thereof include stainless steel, nickel, aluminum, and copper. Among them, stainless steel, and copper are particularly preferable.

Examples of the shape of the collector include a sheet shape, and a mesh shape.

The size of the collector is not particularly limited as long as it is a size that can be used for the nonaqueous electrolyte secondary battery.

As for a material of the anode collector, moreover, lithium titanate can be used. The lithium titanate is represented by the general formula: LixTiyO₄ (0.8≦x≦1.4, 1.6≦y≦2.2). In the case where X-ray diffraction spectroscopy is performed with Cu as a target, there are peaks at least at 4.84 \acute{Å}, 2.53 \acute{Å}, 2.09 \acute{Å}, 1.48 \acute{Å}(each ±0.02 \acute{Å}). Moreover, preferred is lithium titanate whose the peak intensity ratio [the peak intensity at 4.84 \acute{Å}:the peak intensity at 1.48 \acute{Å}(each ±0.02 \acute{Å})]=100:30 (±10).

In the general formula: LixTiyO₄, moreover, preferred are x=1 and y=2, x=4/3 and y=5/3, and x=0.8 and y=2.2.

In the case where rutile crystals of titanium oxide are present together with lithium titanate, moreover, there are peaks at 3.25 \acute{Å}, 2.49 \acute{Å}, 2.19 \acute{Å}, and 1.69 \acute{Å}(each ±0.02 \acute{Å}) in addition to the peaks of the lithium titanate in the X-ray diffraction spectrum thereof.

The preferable peak intensity ratio is (the peak intensity at 3.25 \acute{Å}:the peak intensity at 2.49 \acute{Å}:the peak intensity at 1.69 \acute{Å})=100:50(±10):60(±10).

In the general formula: LixTiyO₄, moreover, preferred are x=1 and y=2, x=4/3 and y=5/3, and x=0.8 and y=2.2.

Meanwhile, a production method of the anode of the lithium secondary battery using the lithium titanate contains: mixing a lithium compound and titanium oxide; and subjecting the mixture to a heat treatment at 800° C. to 1,600° C. to calcinate lithium titanate. As for the lithium compound, which is a starting material of calcination, lithium hydroxide or lithium carbonate is used.

The temperature of the heat treatment is more preferably 800° C. to 1,100° C.

### —Production Method of Anode—

A production method of the anode is appropriately selected depending on the intended purpose without any limitation. For example, the anode can be produced by adding the optional binder, thickening agent, conducting agent, and solvent to the anode active material to prepare slurry, applying the slurry to a substrate of a collector, and drying.

As for the solvent, any of those listed in the production method of the cathode can be used.

Moreover, a mixture, in which a binder and/or a conducting agent is added to the anode active material, may be subjected to roll molding to form a sheet electrode, or to compression molding to form a pellet electrode. Alternatively, a thin film of the anode active material may be formed on the anode collector by vapor deposition, sputtering, or plating.

### <Nonaqueous Electrolyte>

The nonaqueous electrolyte is an electrolyte, in which an electrolyte salt is dissolved in a nonaqueous solvent.

### —Nonaqueous Solvent—

As for the nonaqueous solvent, an aprotic organic solvent is used. The aprotic organic solvent is preferably a solvent having a low viscosity, and examples thereof include a chain or cyclic carbonate-based solvent, a chain or cyclic ether-based solvent, and a chain or cyclic ester-based solvent. These may be used alone, or in combination.

Examples of the chain carbonate-based solvent include dimethyl carbonate (DMC), diethyl carbonate (DEC), and ethylmethyl carbonate (EMC).

Examples of the cyclic carbonate-based solvent include propylene carbonate (PC), ethylene carbonate (EC), butylene carbonate (BC), and vinylene carbonate (VC).

Examples of the chain ether-based solvent include 1,2-dimethoxy ethane (DME), diethyl ether, ethylene glycol dialkyl ether, diethylene glycol dialkyl ether, triethylene glycol dialkyl ether, and tetraethylene glycol dialkyl ether.

Examples of the cyclic ether-based solvent include tetrahydrofuran, alkyl tetrahydrofuran, alkoxy tetrahydrofuran, dialkoxy tetrahydrofuran, 1,3-dioxolan, alkyl-1,3-dioxolan, and 1,4-dioxolan.

Examples of the chain ester-based solvent include alkyl propionate, dialkyl malonate, and alkyl acetate.

Examples of the cyclic ester-based solvent include γ-butyrolactone (γBL), 2-methyl-γ-butyrolactone, acetyl-γ-butyrolactone, and γ-valerolactone.

Among them, preferred is the one containing DMC, DEC, EMC, and/or PC as a main component.

### —Electrolyte Salt—

As for the electrolyte salt, used is an electrolyte salt that is dissolved in a nonaqueous solvent, and a high ion conductivity.

Examples thereof include a combination of the following cation and anion, but various electrolyte salts that can be dissolved in the nonaqueous solvent can be used.

Examples of the cation include an alkali metal ion, an alkaline earth metal ion, a tetraalkyl ammonium ion, and a spiro quaternary ammonium ion.

Examples of the anion include Cl⁻, Br⁻, I⁻, SCN⁻, ClO₄⁻, BF₄⁻, PF₆⁻, SbF₆⁻, CF₃SO₃, (CF₃SO₂)₂N⁻, (C₂F₅SO₂)₂N, and (C₆H₅)₄B⁻.

In view of an improvement of a capacity of a resulting secondary battery, preferred is a lithium salt containing a lithium cation.

The lithium salt is appropriately selected depending on the intended purpose without any limitation. Examples thereof include lithium hexafluorophosphate (LiPF₆), lithium perchlorate (LiClO₄), lithium chloride (LiC₁), lithium fluoroborate (LiBF₄), LiB(C₆H₅)₄, lithium hexafluoroarsenate (LiAsF₆), lithium trifluorosulfonate (LiCF₃SO₃), lithium bistrifluoromethylsulfonyl imide [LiN(C₂F₅SO₂)₂], and lithium bisperfluoroethylsulfonyl imide [LiN(CF₂F₅SO₂)₂]. These may be used alone, or in combination. Among them, LiPF₆, and LiBF₄ are preferable.

The concentration of the lithium salt in the nonaqueous solvent is appropriately selected depending on the intended purpose without any limitation, but the concentration thereof is preferably 0.5 mol/L to 6 mol/L, and particularly preferably in the approximate range of 2 mol/L to 4 mol/L in order to attain both the desirable capacity and output of the battery.

### <Separator>

The separate is preferably provided between the cathode and the anode in order to prevent short circuits between the cathode and the anode.

A material, shape, size, and structure of the separator are appropriately selected depending on the intended purpose without any limitation.

Examples of the material of the separator include: paper, such as kraft paper, vinylon blended paper, and synthetic pulp blended paper; polyolefin nonwoven fabric, such as cellophane, a polyethylene graft membrane, and polypropylene melt-flow nonwoven fabric; polyamide nonwoven fabric; and glass fiber nonwoven fabric.

Examples of the shape of the separator include a sheet shape.

The size of the separator is not particularly limited, as long as it is a size that can be used for the nonaqueous electrolyte secondary battery.

The structure of the separator may be a single layer structure, or a multilayer structure.

### <Other Members>

Other members are appropriately selected depending on the intended purpose without any limitation, and examples thereof include a battery tin, and an electrode lead wire.

### <Production Method of Nonaqueous Electrolyte Secondary Battery>

The nonaqueous electrolyte secondary battery of the present invention can be produced by assembling the cathode, the anode, the nonaqueous electrolyte, and the optional separator into an appropriate shape. Moreover, other members, such as a battery outer tin, can be used according to the necessity. A method for assembling the battery is appropriately selected from commonly employed methods without any limitation.

### —Shape—

A shape of the secondary battery of the present invention is appropriately selected from various shapes typically used depending on the intended use. Examples of the shape thereof include a cylinder-shaped battery where a sheet electrode and a separator are spirally provided, a cylinder-shaped battery having an inside-out structure, in which a pellet electrode and a separator are used in combination, and a coin-shaped battery, in which a pellet electrode and a separator are laminated.

When the concentration of the solute in the electrolyte is reduced to 0 by charging, the battery cannot be charged any more. Therefore, an amount of the solute, which counterbalances the capacities of the cathode and anode, needs to be dissolved in the electrolyte. In the case where the concentration of the solute is low, a large amount of the electrolyte is required in the battery. Therefore, the concentration of the solute in the electrolyte is preferably high. Depending on a case, it is also possible to leave a state where the solute is precipitated in the solvent when discharged.

In view of the points mentioned above, the concentration of the lithium salt in the nonaqueous electrolyte is typically 0.05 mol/L to 5 mol/L, preferably 0.5 mol/L to 4 mol/L, and particularly preferably 1 mol/L to 3 mol/L. When the concentration thereof is lower than 0.05 mol/L, the conductivity may be low, or the energy density of the battery per weight or volume tends to be low, as a large amount of the electrolyte is required to secure the solute counterbalances the capacities of the cathode and anode. When the concentration thereof is higher than 5 mol/L, the solute may be precipitated, or the conductivity may be low.

### [Aging of Secondary Battery]

The secondary battery of the present invention may be subjected to aging. As for the method thereof, charge and discharge are performed the predetermined time so that the capacity is to be 100% SOC (SOC=100%) or greater, which is arbitrarily set.

In the case a battery composed of a cathode and an anode is charged, moreover, the same effect can be obtained by changing charge termination voltage depending on a type of an anode for use, setting charge termination voltage of a cathode to the predetermined voltage when lithium is used as a reference electrode, and specifying a charge method in the manner that the charged state of the charge terminal of the cathode is to be in the predetermined state.

When the charging speed (rate) is too fast, the charge termination voltage is reached before the cathode and the anode are sufficiently charged. Therefore, a sufficient capacity cannot be attained. In the case where charge is carried out with constant electric current, charge is typically preferably performed at the charging speed of 1 C (1 C is a value of electric current with which a rated capacity according a discharge capacity at hourly rate is discharged over 1 hour) or less. When the charging speed is significantly slow, however, it takes a long time to charge. In the case charge is performed with constant electric current, therefore, the charging speed is preferably 0.01 C or greater.

Note that, it is also possible to charge with maintaining the voltage after reaching the charge termination voltage.

When the temperature of the battery is excessively high during charge, decomposition of the nonaqueous electrolyte tends to occur. When the temperature thereof is low, charge to the cathode and the anode may be insufficiently performed. Therefore, charge is typically performed at around room temperature.

A discharge method of the secondary battery of the present invention obtained by being charged in the aforementioned manner varies depending on a discharging speed, or a type of an anode for use. A rating discharge capacity is substantially attained by performing discharge from the charged state typically at the discharging speed of 1 C or less, using the value of about 2 V to about 3 V as discharge termination voltage. For example, the discharge capacity per cathode active material of 60 mAh/g or greater, particularly a high discharge capacity of about 80 mAh/g to about 120 mAh/g can be attained.

### —Shape—

A shape of the nonaqueous electrolyte secondary battery of the present invention can be appropriately selected from various shapes typically used depending on the intended purpose without any limitation. Examples of the shape thereof include a cylinder-shaped battery where a sheet electrode and a separator are spirally provided, a cylinder-shaped battery having an inside-out structure, in which a pellet electrode and a separator are used in combination, and a coin-shaped battery, in which a pellet electrode and a separator are laminated.

### <Use>

Use of the nonaqueous electrolyte secondary battery of the present invention is not particularly limited, and the nonaqueous electrolyte secondary battery of the present invention can be used for various types of use. Examples thereof include a laptop computer, a stylus-operated computer, a mobile computer, an electronic book player, a mobile phone, a mobile fax, a mobile printer, a headphone stereo, a video movie, a liquid crystal television, a handy cleaner, a portable CD, a minidisk, a transceiver, an electronic organizer, a calculator, a memory card, a mobile tape recorder, a radio, a back-up power supply, a motor, a lighting equipment, a toy, a game equipment, a clock, a strobe, and a camera.

### EXAMPLES

The present invention is more specifically explained through Examples hereinafter, but Examples shall not be construed as to limit the scope of the present invention. Note that, in Examples, the charge termination voltage of a cathode a reference electrode of which is lithium is referred to as “charge termination voltage (vs.Li),” and “part(s)” and “%” are both weight basis, unless otherwise stated.

### Example 1

The following graphite particles were prepared. The graphite particles were artificial graphite, and are spherical graphitized particles formed by calcining mesophase carbon at 2,800° C. to graphitize.

An analysis of the graphite particles was performed in the following manners.

(1) A BET specific surface area of the graphite particles was measured by means of a specific surface area measuring device (Gemini2375, manufactured by Shimadzu Corporation). As for the adsorbing agent, nitrogen was used, and the adsorption temperature was set to 77 K.
(2) By means of Raman spectrometer (laser Raman spectrometer NRS-3100, manufactured by JASCO Corporation), the peak intensity ratio I(1360)/I(1580) of the peak intensity at 1,360 cm⁻¹ to the peak intensity at 1,580 cm⁻¹ in the Raman spectrum was determined.

The graphite particles had the BET specific surface area of 10 m²/g to 300 m²/g, the peak intensity ratio (IB/IA) of 0.3 or greater, which was the ratio of the peak intensity of the rhombohedron to that of the hexagonal crystal as measured by X-ray diffraction, and the peak intensity ratio (1360)/I(1580) of 0.11 to 0.30, which was measured by Raman spectroscopy.

Graphite-carbon composite particles were produced by means of a carbon coating device (a device utilizing chemical vapor deposition (CVD)) in the following manner.

In a cuvette formed of quartz placed inside a furnace heated to 1,100° C., the graphite particles were placed. To this, xylene vapor was introduced using argon gas as a carrier, to thereby precipitate and carbonize xylene on the graphite. The precipitation carbonization treatment was carried out for 3,600 seconds. The obtained coated graphite was analyzed. As a result, there were a peak at 1,360 cm⁻¹ and a peak at 1,580 cm⁻¹ in the Raman spectrum of 0.02 to 0.30. The peak intensity ratio I(1360)/I(1580) was 0.16.

### <Production of Cathode>

By means of a non-bubbling kneader NBK1 (manufactured by NIHONSEIKI KAISHA LTD.), 3 g of the aforementioned graphite-carbon composite particles, and 4 g of an acetylene black (AB) solution (20% AB dispersed product, manufactured by MIKUNI COLOR LTD., H₂O solvent based solution where SA black model number: A1243 was diluted to give 5-fold dilution: 5% AB-H₂O) were kneaded for 15 minutes at 1,000 rpm. To this, 1 g to 3 g of a CMC (3%) aqueous solution was added to adjust the conductivity and the viscosity. Subsequently, the kneaded product was shaped on an aluminum sheet of 18 μm by means of a film forming device, to thereby obtain a cathode.

### <Production of Anode>

As for an anode material, 3 g of LTO (Li₄Ti₅O₁₂, manufactured by Titan Kogyo, Ltd.), and 4 g of an acetylene black solution (manufactured by MIKUNI COLOR LTD., a 5 fold-dilution solution of AB: 5% AB-H₂O) were kneaded by means of a non-bubbling kneader NBK1 (manufactured by NIHONSEIKI KAISHA LTD.) for 15 minutes at 1,000 rpm. To the resultant, a CMC (3%) aqueous solution was added in an amount of 1 g to 3 g, to adjust the conductivity and the viscosity. Subsequently, the kneaded product was shaped on an aluminum sheet of 18 μm by means of a film forming device, to thereby obtain an anode.

### <Electrolyte>

As an electrolyte, 0.3 mL of a solvent [(EC/PC=1/1, manufactured by KISHIDA CHEMICAL Co., Ltd.], in which 1 mol of LiBF₄ had been dissolved, was prepared.

### <Separator>

As a separator, a laboratory filter paper (ADVANTEC GA-100 GLASS FIBER FILTER) was provided.

### <Production of Battery>

A coin-type nonaqueous electrolyte secondary battery was produced using the prepared cathode, anode, electrolyte, and separator, by placing the cathode and anode, both of which had been pinched to give a diameter of 16 mm, adjacent to each other with the separator being placed between the cathode and the anode.

Various properties of the nonaqueous electrolyte secondary battery were investigated in the following manners.

### <Charge-Discharge Behavior>

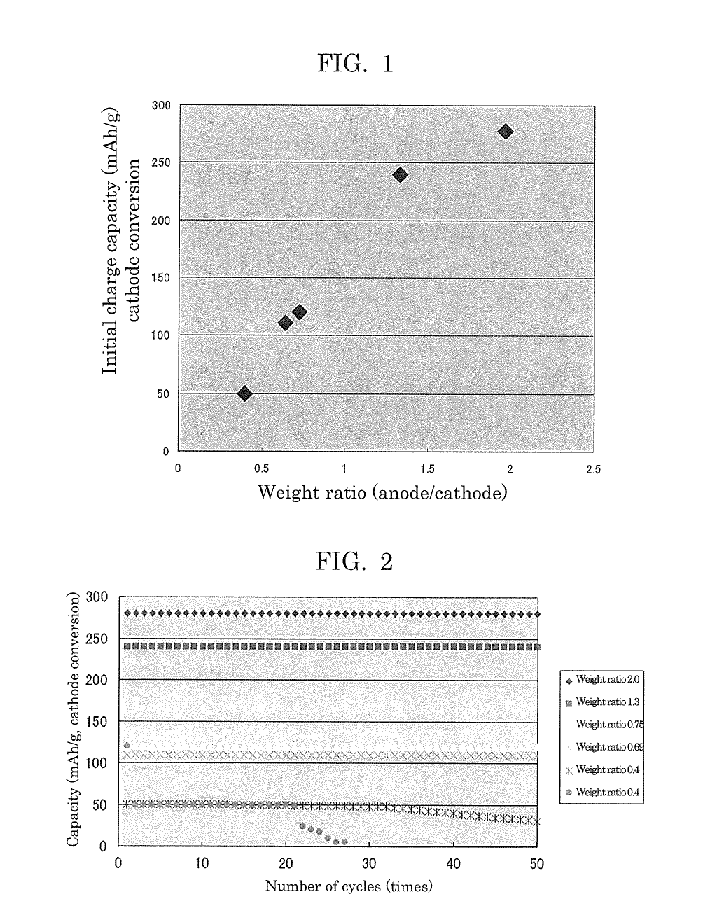

The weight ratio (anode/cathode) of the active material of the anode to the active material of the cathode was varied, and the battery was charged to the charge termination voltage of 4.5 V at room temperature by means of TOSCAT-3100 manufactured by TOYO SYSTEM CO., LTD. with constant electric current of 0.57 mA/cm². As a result, the first charge capacity per cathode active material of 50 mAh/g to 280 mAh/g was obtained with dependency to the weight ratio, as depicted in FIG. 1.

The discharge capacity when the battery was discharged to 2.5 V with constant electric current of 0.57 mA/cm² after the first charge was 60 mAh/g to 100 mAh/g with dependency to the weight ratio (anode/cathode).

SOC can be appropriately determined depending on an intended use of a battery. Therefore, the full charge capacity is not necessarily determined as 100% SOC, as long as 100% SOC satisfies the capacity of the intended use. Here, 100% SOC was determined as an arbitrary capacity indicating that electric potential of the anode is reduced by 5% or greater based on a relative value, compared to electric potential thereof when SOC was 0%.

As described above, the discharge capacity of the secondary battery was 60 mAh/g to 100 mAh/g. In order to secure a discharge capacity equal to the charge capacity without any problem, 100% SOC of the secondary battery was determined as 48 mAh/g, which was 80% of the lowest value 60 mAh/g. by converting into a capacity per cathode active material.

Accordingly, it was found from FIG. 1 that charge and discharge of 100% SOC could be achieved with the weight ratio (anode/cathode) of 0.4 or greater.

The results obtained by repeatedly performed charge-discharge cycles achieving 100% SOC or greater on the secondary battery whose the weight ratio (anode/cathode) was charged were depicted in FIG. 2 (5 lines from the top are lines of the weight ratio (anode/cathode) of 2.0 to 0.4).

As clear from FIG. 2, the secondary battery was stable even when the voltage reaching the overcharge region was applied, and thus there was no immediate trouble, for example, when the battery was overcharged due to breakdown of circuits. For example, in the case where the circuits were broke down, the breakdown of the circuits, or the charge reaching the overcharge region did not continuously and repeatedly occur. It was then judged in the present invention that it was safe when voltage reaching the overcharge region was applied to the secondary battery 20 times. For example, in the case where the circuits were broke down, the breakdown of the circuit or the charge reaching the overcharge region did not continuously and repeatedly occur. Therefore, the secondary battery was considered as safe, when it was stable after performing charge and discharge a few times.

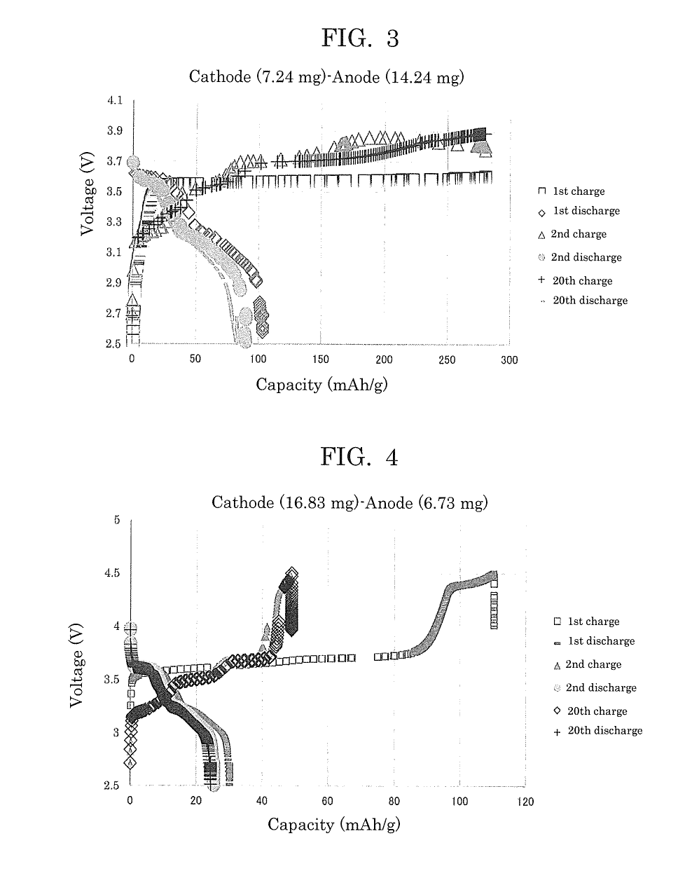

FIG. 3 depicts one example of a charge-discharge curve of the secondary batter [the weight ratio (anode/cathode) of which is 2.0 (anode/cathode=14.24 mg/7.24 mg)].

As is clear from FIG. 3, in this case, the capacity of the cathode graphite is about 280 mAh/g.

Considering that the capacity of BF₄C₆ at the first stage is about 370 mAh/g, and the capacity of BF₄C₁₂ at the second stage is about 180 mAh/g (both geometric capacities known in the art), BF₄ ions are inserted into the first state with the charge to the cathode. Specifically, this secondary battery gives a capacity of 280 mAh/g, and it is assumed that ions of 280−180=100 mAh/g are inserted into the second stage, compared to the capacity of BF₄C₁₂ of the second stage being about 180 mAh/g.

However, the voltage is insufficient to completely fill the first stage, and the voltage of 4.5 V or greater is required. Specifically, the first stage is unfilled by 370−100=270 mAh/g, it is necessary to charge with the further increased voltage, in order to charge to 270 mAh/g.

Moreover, the charge electric potential of about 4.4 V is a charge curve of the first and second stages. Specifically, there is a flat area called a plateau at 4.4 V. In this area, the capacity is increased with no increase in the voltage, and therefore charge can be carried out. Therefore, charge of the first stage and the second stage is performed on this secondary battery.

The inflection points are appeared at 120 mAh/g and 180 mAh/g, which respectively correspond to a third stage of XC18 the geometric capacity of which is 120 mAh/g, and a second stage of XC12 the geometric capacity of which is 180 mAh/g. Accordingly, in order to make the battery safer, the overcharge region is 120 mAh/g or greater, preferably 180 mAh/g or greater.

### Example 2

A cell was produced in the same manner as in Example 1, provided that a weight ratio of the cathode and the anode was changed to the weight ratio (anode/cathode) of 0.4, where the cathode was 8.4 mg/cm², and the anode was 3.4 mg/cm², and the cycle characteristics thereof up to the overcharge region were measured. As a result, the discharge capacity was 24 mAh/g, as depicted in FIG. 4. In this case, SOC can be set to 24 mAh/g, and the overcharge region can be set to 24 mAh/g or greater.

As indicated with the most bottom line of FIG. 4, the battery was not deteriorated for the first 21 cycles, but a charge capacity thereof was reduced at the 22^{nd} cycle.

### Example 3

A nonaqueous electrolyte secondary battery was produced in the same manner as in Example 1, provided that the electrolyte was changed to PC, in which 1M of LiBF₄ had been dissolved.

The voltage reaching the overcharge region was applied to the secondary battery, but the secondary battery was not deteriorated for the first 21 cycles.

### Example 4

A nonaqueous electrolyte secondary battery was produced in the same manner as in Example 1, provided that the cathode material was replaced with the following material.

As for the cathode active material, a commercial graphite powder (KS-6, manufactured by TIMCAL Company, Ltd.) having the following physical properties was used.

This graphite powder was subjected to powder X-ray diffraction spectroscopy using CuKα rays. In the resulting spectrum thereof, I_{2θ=22.3}/I_{2θ=26.4} was 0.017. According to the values depicted in the manufacturer's catalog, moreover, the BET specific surface area thereof as measured by nitrogen adsorption was 20 m²/g, and the median diameter thereof as measured by a laser diffraction particle size distribution analyzer was 3.4 μm.

The voltage reaching the overcharge region was applied to the secondary battery, but the secondary battery was not deteriorated for the first 50 cycles.

### Example 5

A nonaqueous electrolyte secondary battery was produced in the same manner as in Example 1, provided that the anode was replaced with a graphite-based anode (MAGD, graphite-based anode, manufactured by Hitachi Chemical Company, Ltd.).

The voltage reaching the overcharge region was applied to the secondary battery, but the secondary battery was not deteriorated for the first 50 cycles.

### Example 6

A nonaqueous electrolyte secondary battery was produced in the same manner as in Example 1, provided that the anode was replaced with a graphite-based anode (MAGD, a graphite-based anode, manufactured by Hitachi Chemical Company, Ltd.), and the electrolyte was replaced with a EC/DMC solution (EC/DMC=1/2), in which 1 M of LiPF₆ had been dissolved.

The voltage reaching the overcharge region was applied to the secondary battery, but the secondary battery was not deteriorated for the first 21 cycles.

The embodiments of the present invention are, for example, as follows:

<1> A nonaqueous electrolyte secondary battery, containing:

an anode capable of accumulating or releasing metal lithium, or a lithium ion, or both;

a cathode relative to the anode; and

a nonaqueous electrolyte, in which a lithium salt is dissolved in a nonaqueous solvent,

wherein, after repeating charge of the nonaqueous electrolyte secondary battery to an overcharge region and discharge for the charge 20 times, a charge capacity of the nonaqueous electrolyte secondary battery for 21st charge is a capacity equal to or greater than 100% SOC (State of Charge), where 100% SOC is an arbitrary capacity indicating that electric potential of the anode is reduced by 5% or greater based on a relative value, compared to electric potential thereof when SOC is 0%.

<2> The nonaqueous electrolyte secondary battery according to <1>, wherein the charge capacity of the cathode is 58 mAh/g or greater.
<3> The nonaqueous electrolyte secondary battery according to <1>, wherein the charge capacity of the cathode is 120 mAh/g or greater.
<4> The nonaqueous electrolyte secondary battery according to <1>, wherein the charge capacity of the cathode is 180 mAh/g or greater.
<5> The nonaqueous electrolyte secondary battery according to any one of <1> to <4>, wherein the cathode contains a carbonaceous material.
<6> The nonaqueous electrolyte secondary battery according to <5>, wherein the carbonaceous material is graphite.
<7> The nonaqueous electrolyte secondary battery according to <6>, wherein the graphite is graphite particles in the form of particles.
<8> The nonaqueous electrolyte secondary battery according to <7>, wherein the cathode contains graphite-carbon composite particles each including the graphite particle, and a carbon layer covering the graphite particle.
<9> The nonaqueous electrolyte secondary battery according to <8>, wherein the carbon layer is formed of crystalline carbon.
<10> The nonaqueous electrolyte secondary battery according to any one of <1> to <9>, wherein a weight ratio of an active material of the anode to an active material of the cathode, which is represented by (the active material of the anode/the active material of the cathode), is 0.4 or greater.
<11> The nonaqueous electrolyte secondary battery according to any one of <1> to <10>, wherein the anode contains lithium titanate, which is produced by calcining a lithium compound and titanium oxide, and is represented by the general formula: LixTiyO₄ (0.8≦x≦1.4, 1.6≦y≦2.2).
<12> A nonaqueous electrolyte secondary battery, containing:

an anode capable of accumulating and releasing metal lithium, or a lithium ion, or both;

a cathode relative to the anode; and

a nonaqueous solvent, in which lithium salt is dissolved in a nonaqueous electrolyte, wherein the cathode contains graphite-carbon composite particles each containing a graphite particle, and a carbon layer covering the graphite particle, the anode contains lithium titanate represented by the general formula: LixTiyO₄ (0.8≦x≦1.4, 1.6≦y≦2.2), and a weight ratio of an active material of the anode to an active material of the cathode, which is represented by (the active material of the anode/the active material of the cathode), is 0.4 or greater, and

wherein, after repeating charge of the nonaqueous electrolyte secondary battery to 100% SOC or greater and discharge of the nonaqueous electrolyte secondary battery for the charge twice, a charge capacity of the nonaqueous electrolyte secondary battery for third charge is a capacity equal to or greater than 100% SOC (State of Charge), where 100% SOC is an arbitrary capacity indicating that electric potential of the anode is reduced by 5% or greater based on a relative value, compared to electric potential thereof when SOC is 0%.

<13> The nonaqueous electrolyte secondary battery according to <1> or <12>, wherein the charge capacity of the cathode is 24 mAh/g or greater.

1. A nonaqueous electrolyte secondary battery, comprising:
an anode capable of accumulating or releasing metal lithium, or a lithium ion, or both;
a cathode relative to the anode; and
a nonaqueous electrolyte, in which a lithium salt is dissolved in a nonaqueous solvent,
wherein, after repeating charge of the nonaqueous electrolyte secondary battery to an overcharge region and discharge for the charge 20 times, a charge capacity of the nonaqueous electrolyte secondary battery for 21st charge is a capacity equal to or greater than 100% SOC (State of Charge), where 100% SOC is an arbitrary capacity indicating that electric potential of the anode is reduced by 5% or greater based on a relative value, compared to electric potential thereof when SOC is 0%.

2. The nonaqueous electrolyte secondary battery according to claim 1, wherein the charge capacity of the cathode is 58 mAh/g or greater.

3. The nonaqueous electrolyte secondary battery according to claim 1, wherein the charge capacity of the cathode is 120 mAh/g or greater.

4. The nonaqueous electrolyte secondary battery according to claim 1, wherein the charge capacity of the cathode is 180 mAh/g or greater.

5. The nonaqueous electrolyte secondary battery according to claim 1, wherein the cathode contains a carbonaceous material.

6. The nonaqueous electrolyte secondary battery according to claim 5, wherein the carbonaceous material is graphite.

7. The nonaqueous electrolyte secondary battery according to claim 6, wherein the graphite is graphite particles in the form of particles.

8. The nonaqueous electrolyte secondary battery according to claim 7, wherein the cathode contains graphite-carbon composite particles each including the graphite particle, and a carbon layer covering the graphite particle.

9. The nonaqueous electrolyte secondary battery according to claim 8, wherein the carbon layer is formed of crystalline carbon.

10. The nonaqueous electrolyte secondary battery according to claim 1, wherein a weight ratio of an active material of the anode to an active material of the cathode, which is represented by (the active material of the anode/the active material of the cathode), is 0.4 or greater.

11. The nonaqueous electrolyte secondary battery according to claim 1, wherein the anode contains lithium titanate, which is produced by calcining a lithium compound and titanium oxide, and is represented by the general formula: LixTiyO₄ (0.8≦x≦1.4, 1.6≦y≦2.2).

12. A nonaqueous electrolyte secondary battery, comprising:
an anode capable of accumulating and releasing metal lithium, or a lithium ion, or both;
a cathode relative to the anode; and
a nonaqueous solvent, in which lithium salt is dissolved in a nonaqueous electrolyte,
wherein the cathode contains graphite-carbon composite particles each containing a graphite particle, and a carbon layer covering the graphite particle, the anode contains lithium titanate represented by the general formula: LixTiyO₄ (0.8≦x≦1.4, 1.6≦y≦2.2), and a weight ratio of an active material of the anode to an active material of the cathode, which is represented by (the active material of the anode/the active material of the cathode), is 0.4 or greater, and
wherein, after repeating charge of the nonaqueous electrolyte secondary battery to 100% SOC or greater and discharge of the nonaqueous electrolyte secondary battery for the charge twice, a charge capacity of the nonaqueous electrolyte secondary battery for third charge is a capacity equal to or greater than 100% SOC (State of Charge), where 100% SOC is an arbitrary capacity indicating that electric potential of the anode is reduced by 5% or greater based on a relative value, compared to electric potential thereof when SOC is 0%.

13. The nonaqueous electrolyte secondary battery according to claim 1, wherein the charge capacity of the cathode is 24 mAh/g or greater.

14. The nonaqueous electrolyte secondary battery according to claim 12, wherein the charge capacity of the cathode is 24 mAh/g or greater.
